(19) United States
(12) Patent Application Publication
(10) Pub. No.: US 2023/0209119 A1
(43) Pub. Date: Jun. 29, 2023

(54) METHOD AND APPARATUS FOR CONTROLLING DIGITAL CONTENT PLAYBACK AND SYNCHRONIZED WIRELESS LIGHTING DEVICE

(71) Applicant: Eumhana Co.,Ltd., Geumcheon-gu, Seoul (KR)

(72) Inventor: Sang Min Jo, Bucheon-si, Gyeonggi-do (KR)

(73) Assignee: Eumhana Co., Ltd., Geumcheon-gu, Seoul (KR)

(21) Appl. No.: 17/996,107

(22) PCT Filed: Jul. 22, 2020
(86) PCT No.: PCT/KR2020/009647

§ 371 Date: Oct. 13, 2022

(30) Foreign Application Priority Data
Apr. 14, 2020 (KR) 10-2020-0045465

(51) Int. Cl. H04N 21/41; H04N 21/436; H05B 47/165; H05B 47/19

(52) U.S. Cl. CPC H04N 21/4131; H04N 21/43615; H05B 47/19; H05B 47/165

(57) ABSTRACT

Disclosed is a method for controlling digital content playback and a wireless lighting device. The method controls playback of the media data, and controls transmission of the lighting control data to the wireless lighting device based on a relevant event of the media data playback.

### TECHNICAL FIELD

The present disclosure relates to a method and apparatus for controlling digital content playback and a wireless lighting device and, in particular, to a method and apparatus for providing additional lighting producing and entertainment effects by enabling a wireless lighting device wirelessly connected to a user device to provide lighting while being synchronized with digital content playback.

### BACKGROUND ART

Thanks to the advancement of communication technology and semiconductor technology, the size of communication equipment has become very small. And, with the introduction of Internet of Things (IoT) technology, communication between many home appliances and portable devices has become possible.

Most of the producing effects of the existing performance halls were realized by the lighting and sound effects provided in the performance halls. The audience in the performance hall would use cell phones and lighting devices such as light sticks. The lighting/light emitting devices include lighting elements such as LCDs and LEDs, and provide lighting effects. The lighting devices may emit light in various colors. However, now that communication equipment is added to the lighting device, it has become capable of performance producing by using the wireless lighting devices of the audience.

### SUMMARY OF INVENTION

### Technical Problem

Due to the recent improvement in the speed of communication networks, it is possible to implement various entertainment systems in a virtual space, which go beyond space limitations. The performance image of the performance hall can be immediately converted into digital content and streamed in real time. And, the producing in the performance hall using the wireless lighting device may also be provided in other places, such as home, than the performance hall. However, there is a need for the producing of the wireless lighting device linked and synchronized with the digital media content.

### Solution to Problem

In order to solve the above technical problem, a method for controlling digital content playback and a wireless lighting device synchronized with the digital content playback is disclosed. A control method according to an embodiment of the present disclosure includes: obtaining identification information about media data of the digital content selected to be played; establishing a communication connection with at least one wireless lighting device; obtaining first lighting control data for lighting control of the wireless lighting device for the digital content by using the identification information; controlling playback of the media data, and controlling real-time transmission of second lighting control data to the wireless lighting device based on at least one event related to the playback of the media data.

### Advantageous Effects

According to the present disclosure, the wireless lighting device can provide the lighting in synchronization with the lighting effect of the digital content, or provide additional feedback. Accordingly, the support effect of the fandom is improved, and the lighting device can be operated in linkage with various contents. In addition, even in a live performance, an additional producing effect can be provided to an image by the wireless lighting device providing the lighting in various colors like in the performance hall. As the usage environment of the wireless lighting device is extended outside the performance hall, the sales volume of the wireless lighting devices may also be significantly increased.

### BRIEF DESCRIPTION OF DRAWINGS

FIG. 1 represents a lighting producing system according to an embodiment of the present disclosure.

FIG. 2 represents a lighting producing system and an entertainment system according to an embodiment of the present disclosure.

FIG. 3 is a schematic diagram of a system including an entertainment system according to an embodiment of the present disclosure.

FIG. 4 represents a method for providing digital content and synchronized lighting effects of a user device according to an embodiment of the present disclosure.

FIG. 5 represents a method of transmitting digital content playback and synchronized lighting data of a user device according to an embodiment of the present disclosure.

FIGS. 6 to 8 represent a streaming form/method according to an embodiment of the present disclosure.

FIG. 9 represents a user device performing media content playback and wireless lighting device control according to an embodiment of the present disclosure.

FIG. 10 represents a periodic signal indicating a lighting pattern according to an embodiment of the present disclosure.

FIG. 11 represents various waveforms of a periodic signal according to an embodiment of the present disclosure.

FIG. 12 represents a waveform pattern (A) of a periodic function/signal according to an embodiment of the present disclosure.

FIG. 13 represents a waveform pattern (B) of a periodic function/signal according to another embodiment of the present disclosure.

FIG. 14 represents a method of playing digital content by a user device and controlling a wireless lighting device according to an embodiment of the present disclosure.

### DESCRIPTION OF EMBODIMENTS

Preferred embodiments of the present disclosure will be described in detail, examples of which are shown in the accompanying drawings. The following detailed description with reference to the accompanying drawings is intended to describe preferred embodiments of the present disclosure rather than to show only embodiments that can be implemented according to the embodiments of the present disclosure. The following detailed description includes details in order to provide a thorough understanding of the present disclosure, but the present disclosure does not require all these details. The embodiments described below in the present disclosure do not have to be used separately. Multiple or all embodiments may be used together, and specific embodiments may be used in combination.

Most terms used in the present disclosure are selected from general ones widely used in the art, but some terms are arbitrarily selected by the applicant and their meanings are described in detail as needed in the following description. Accordingly, the present disclosure should be understood based on the intended meaning of the term rather than the simple name or meaning of the term.

The present disclosure relates to an entertainment system for producing a lighting effect. The entertainment system may provide at least one of lighting/visual effect of a specific shape or color, or tactile feedback in an indoor/outdoor/virtual performance hall/concert hall or the like. The visual effect may be implemented by controlling the lighting of at least one wireless lighting device. The entertainment system may also be referred to as a lighting system.

In particular, this disclosure relates to a method for controlling a wireless lighting device by a user device/control system included in an entertainment system. The invention also relates to a method in which a wireless lighting device of the system operates according to a wirelessly transmitted command of the lighting control system. The system provides the lighting effect of the lighting system by transmitting commands wirelessly or by wire. The lighting system includes at least one wireless lighting device.

A method for controlling a lighting system is described in the present disclosure. In this specification, the lighting system includes at least one wireless lighting device. Each wireless lighting device is capable of wireless/wired communication using arbitrary communication protocol. The lighting system includes at least one wireless lighting device which is a target of the producing.

The wireless lighting device refers to any electronic device which includes, or is connected to, a lighting element/device, such as an LCD, an LED, and the like, and is capable of wireless communication. In an embodiment, a wireless light stick, a lighting stick, a lighting bar, a mobile phone, or the like may correspond to this. In this specification, the wireless lighting device may be referred to herein as a lighting device, a receiving device, or a slave device. The wireless lighting device may perform wireless communication based on various communication protocols such as Bluetooth, Zeegbee, WiFi, Long Term Evolution (LTE), NR (New Radio), and RF (Radio Frequency). Hereinafter, the wireless lighting device may be referred to as a lighting device.

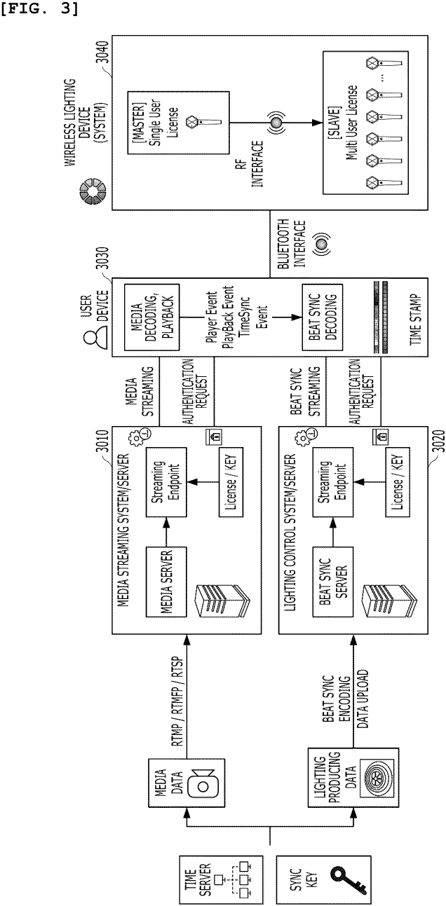

In the present disclosure, the entertainment system includes a user device and at least one wireless lighting device, but may also be used to encompass the overall associated system as shown in FIG. 3.

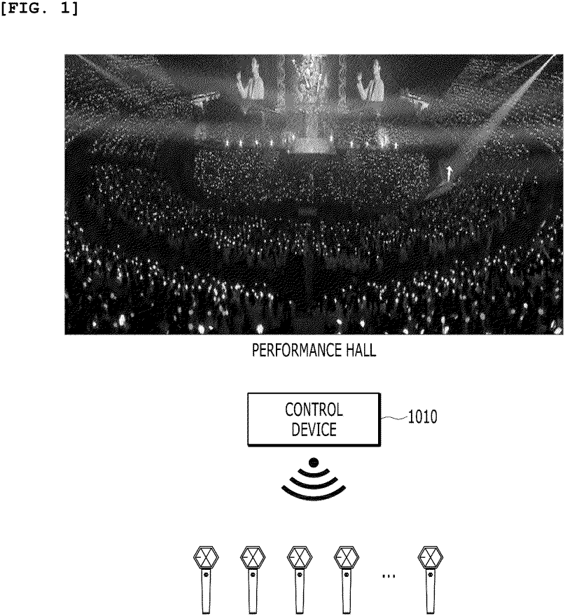

FIG. 1 represents a lighting producing system according to an embodiment of the present disclosure.

In the performance hall, a plurality of wireless lighting devices are carried by the audience, and by controlling the lighting color and timing of the wireless lighting devices, various scenes can be produced. As shown in FIG. 1, a control device 1010 may perform performance producing, such as lighting in different colors depending on the seats, lighting in different colors in order, or the like, by transmitting a wireless control signal to use a plurality of wireless lighting devices.

The control device 1010 may control the wireless lighting devices in a variety of ways. In an embodiment, wireless lighting devices may be mapped to specific coordinate values according to seat/seat number. The control device 1010 may perform producing by transmitting control information according to the producing shape to the wireless lighting devices. In an embodiment, the control device may transmit lighting color information and function information. And, the wireless lighting devices may substitute their coordinate values to the received function information, and determine whether to provide the lighting according to the calculation result.

However, at present, since the wireless lighting device can be operated only by the receiving of the control signal in the performance hall, it may bring a limit to sales. In addition, since it can be used only in a performance hall, there is a problem in that its use is very limited. Therefore, the present disclosure proposes a method for providing a lighting producing effect even in a place other than a performance hall, and to this end, there is proposed a method which can provide a lighting producing effect by interworking with a wireless lighting device when a user device plays digital content.

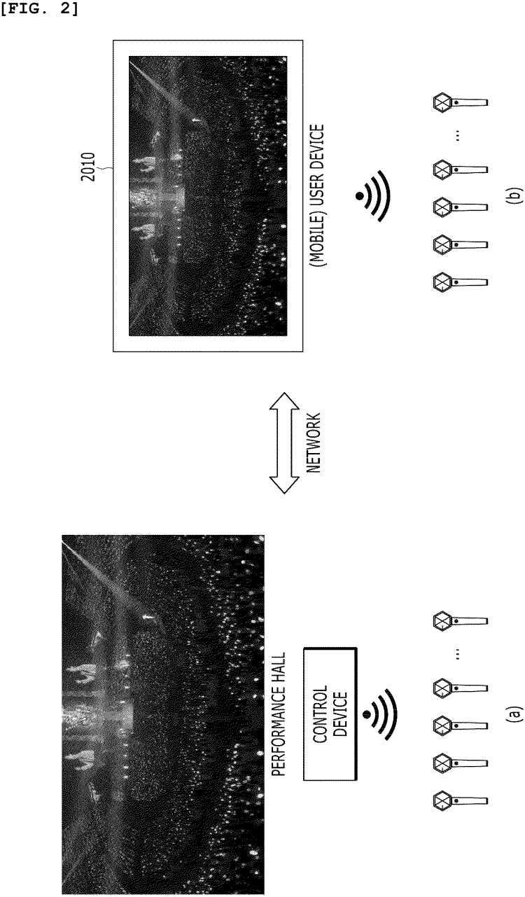

FIG. 2 represents a lighting producing system and an entertainment system according to an embodiment of the present disclosure.

In FIG. 2, portion (a) is the lighting producing system described in FIG. 1. The present disclosure intends to provide such producing effect in a performance hall even when providing digital content through streaming, and portion (b) of FIG. 2 represents an entertainment system according to an embodiment of the present disclosure.

In portion (b) of FIG. 2, the entertainment system includes a user device 2010 and at least one wireless lighting device. The user device 2010 may be connected to a network to download and/or display media data corresponding to the digital content. The user device 2010 may be connected to the Internet by wire or wirelessly to display digital contents such as a performance image in a streaming manner, or to provide an image to a connected display device. The user device 2010 is a device that downloads media data and controls the playback of a digital content, and does not necessarily include a display.

The user device 2010 may wirelessly control at least one wireless lighting device. The user device 2010 may transmit synchronized lighting control data/signals to the wireless lighting device using various wireless communication protocols. The lighting control data may include lighting color information and/or lighting timing information. In an embodiment, the lighting control data/signal may be transmitted as various types of periodic signals, such as one in which the y-axis represents color and the x-axis represents time. In this specification, the lighting control data/signal may also be referred to as the lighting data/signal. The lighting control data/signal will be described in detail again below.

By the control of the user device 2010, the lighting device wirelessly connected to the user device 2010 may provide a lighting effect synchronized with the lighting effect of the digital content. For example, the timing of the lighting effect of the digital content and the lighting timing of the lighting device may be synchronized. As for the lighting color of the lighting device operating in the entertainment system, it may be provided as the main color of the lighting effect of the digital content, or a color different from that of the digital content may be set separately.

FIG. 3 is a schematic diagram of a system including an entertainment system according to an embodiment of the present disclosure.

Media data for media content playback has a reference time, and this reference time is set based on a specific time server. When generating media data, a sync key corresponding to the media content ID is generated, and the sync key may be used for lighting control. Corresponding lighting control data may be stored using a sync key value. The sync key corresponds to an identifier for mapping media data and lighting control data. In this specification, the sync key may be referred to as a media data ID or identification information for media data. For example, media data and lighting control data can be matched/linked with each other by having the same identification information as a file name or including it in a file name.

The media streaming system/server 3010 may transmit media data to the user device 3030. Media data may be transmitted in a file format, or may be transmitted in a streaming method. The user device 3030 may receive media data from the media streaming system/server 3010 via a media data ID (sync key).

The lighting control system/server 3020 may encode lighting producing data used for producing in a performance hall into lighting control data. For example, producing data that transmits color information according to a viewpoint in a performance hall may be encoded in a digital signal format including transmission timing. The user device 3030 may receive the lighting control data from the lighting control system/server 3020 via the media data ID (sync key).

The lighting control system 3020 may transmit data for controlling the lighting of the wireless lighting device 3040 to the user device 3030. The lighting control data may be transmitted in a streaming manner. The lighting control data may also be transmitted in a file manner. In an embodiment, for linear color producing of the wireless lighting device, the transmission of a streaming method of a periodic signal may be controlled. In an embodiment, the lighting control data may be transmitted in a streaming manner or a file manner, and the user device 3030 may transmit the lighting control data to the wireless lighting device 3040 in a streaming manner.

The user device 3030 may request authentication to the media streaming system/server 3010 and the lighting control system/server 3020 when starting playback of specific content, and may receive media data and/or lighting control data. The user device 3030 may provide a lighting effect synchronized with digital content by controlling and transmitting media data and lighting control data in a synchronized manner.

User device 3030 may control one or more wireless lighting devices at the same time. However, one wireless lighting device may perform the role of the master device, and retransmit the received lighting control data to the slave wireless lighting devices. A plurality of wireless lighting devices that are controlled by the user device 3030 to provide a lighting effect may be referred to as a wireless lighting system 3040.

In an embodiment, in the case of single-user license control, the wireless lighting device 3040 controls lighting based on the received lighting data. In the case of multiuser license control, at least one wireless lighting device 3040 controls its own lighting based on the received lighting data, and retransmits the received lighting data. In an embodiment, it is possible to register a target wireless lighting device with which the lighting data is to be shared, and also to control lighting for the registered wireless lighting device.

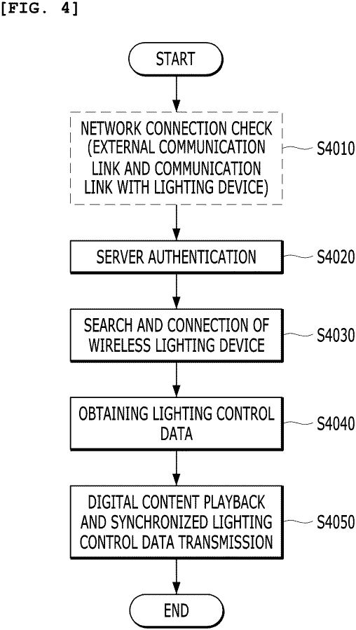

FIG. 4 represents a method for providing digital content and synchronized lighting effects of a user device according to an embodiment of the present disclosure.

The user device may check the network connection (S4010) . However, the network connection check may be omitted depending on the network connection state of the user device. The user device may check a network connection for receiving media data or lighting control data, and/or a network connection for transmitting control signals to the lighting device. In an embodiment, the user device may check an Internet connection and check whether a Bluetooth connection is possible.

The user device may perform server authentication (S4020). When the user selects media content to be played, the user device may obtain an ID and license for the corresponding media data and request ID access to the media data. It may also request access to lighting control data.

In this step, the user device may obtain identification information about the media data of the digital content selected to be played. In addition to the identification information, license information may be obtained. The identification information may be used to request media data to a server for media streaming or media data playback. In addition, this identification information may be used to request and receive lighting control data for media data to/from a separate server.

The user device may search and connect to a wireless lighting device (S4030). In other words, the user device may establish or check a communication connection with the at least one wireless lighting device. The user device may search nearby wireless communication devices based on a specific wireless communication protocol. The user device may select a device having the strongest signal strength or a device selected by the user as a communication connection target, and may obtain an ID of the target device. The user device may request a connection to the device of the target ID, and establish a communication connection with the target device. The user device may monitor the connection state, and perform the above-described operation again when the connection is disconnected.

The user device may obtain lighting control data (S4040). The user device may obtain the lighting control data for the media data by using the above-described identification information.

Additionally, the user device may check whether lighting control data corresponding to digital content exists by transmitting the identification information to the lighting control system/server. If the lighting control data does not exist, the media content may be played directly. If the lighting control data exists, it may be obtained by receiving the lighting control data by requesting it to the lighting control server.

The obtaining of the lighting control data may be classified into two types according to the synchronization type. The synchronization type may be classified into a VOD type in which media content data may be provided in the form of a file, and a live type in which the media content data may be provided in the form of streaming. In the case of the live type, it is necessary to check at regular time intervals whether the lighting control data is updated. The user device may request lighting control data corresponding to a specific content ID to the lighting control system/server. Once the lighting control data is received and decoded, the user device may store/update the lighting control data.

The user device may play the media content, and transmit the synchronized lighting control data (S4050). The user’s digital content playback and transmission of synchronized lighting control data will be detailed below. However, the playback of the media content may include all operations such as data download, buffering, stop, and position change of the media content.

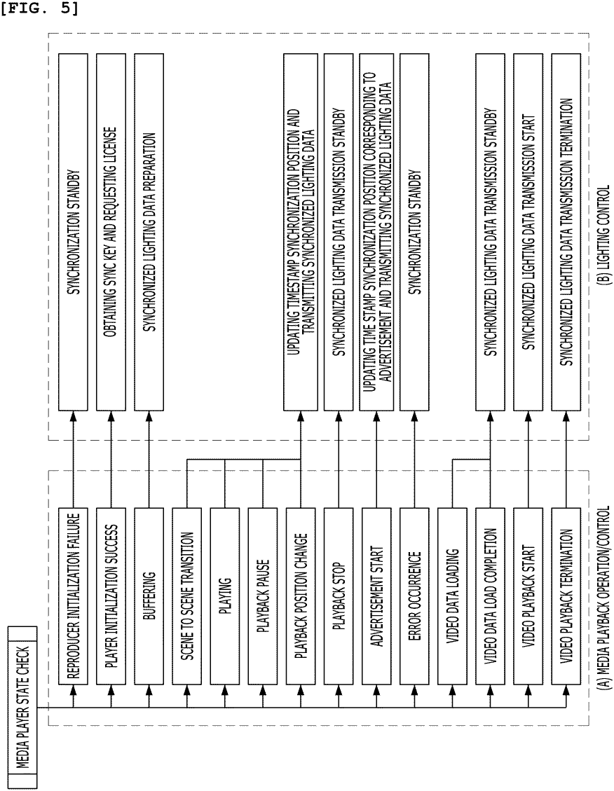

FIG. 5 represents a method of transmitting digital content playback and synchronized lighting data of a user device according to an embodiment of the present disclosure.

In FIG. 5, portion (a) on the left side thereof shows the media playback operation/control, and portion (b) on the right side thereof shows the operation of lighting control. For synchronized lighting control, the user device may perform a lighting control operation according to an operation event in the media player. FIG. 5 may be presented as shown in the table below together with the event name. The media player may produce a lighting effect synchronized with the media content by additionally performing a lighting control operation for the corresponding event.

As shown in Table 1, the transmission of lighting control data is processed in conjunction with the event related to playback. The media data and the lighting control data are set to have the same reference time, the time stamps are synchronized, and the transmission of the lighting control data is controlled according to the operation event of the media data player. Accordingly, the lighting effect synchronized with the displayed media content can be produced by the wireless lighting device.

TABLE 1

| | | |
|---|---|---|
| Event name | Description | Synchronization processing |
| onInitializationFailure | Player initialization failure | Synchronization standby |
| onInitializationSuccess | Player initialization success | Obtaining SYNC KEY and requesting license |
| onFullscreen | Scene to scene transition | Updating timestamp sync position and sending lighting data |
| onBuffering | Buffering | Preparing synchronization data |
| onPlaying | Playing | Updating timestamp sync position and sending lighting data |
| onPaused | Playback pause | Updating timestamp sync position and sending lighting data |
| onSeekTo | Playback position change | Updating timestamp sync position and sending lighting data |
| onStopped | Playback stop | Lighting data transmission stanby |
| onAdStarted | Advertisement start | Updating timestamp synchronization position corresponding to advertisement, and controlling synchronization data |
| onError | Error occurrence | Lighting data transmission stanby |
| onLoading | Video data loading | Lighting data transmission stanby |
| onLoaded | Video data load completion | Synchronization data transmission standby |
| onVideoStarted | Video playback start | Starting lighting data transmission |
| onVideoEnded | Video playback termination | Lighting data transmission termination |

In FIG. 5, the synchronization standby refers to a state before accessing the lighting control server and receiving the lighting data synchronized with digital content. Transmission of synchronized lighting data, as described above, means transmitting data or signals indicating lighting color and lighting time/timing, and such transmission may be performed in real-time/streaming manner.

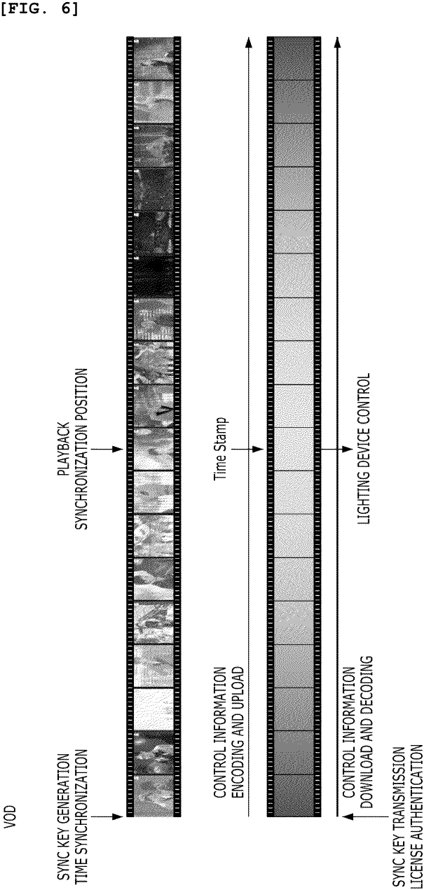

FIGS. 6 to 8 represent a streaming form/method according to an embodiment of the present disclosure.

In FIGS. 6 to 8, control information means lighting control data.

FIG. 6 presents a method of processing by receiving and then synchronizing all lighting control information corresponding to predefined media content, in a VOD manner.

FIG. 7 represents a method of receiving, synchronizing, and processing new data after updating lighting control information to a server according to media content in real time, in a live method.

FIG. 8 present a method of processing by synchronizing after partially receiving the lighting control information tailored to the predefined media content in accordance with the media content in real time, in a VOD+ live manner.

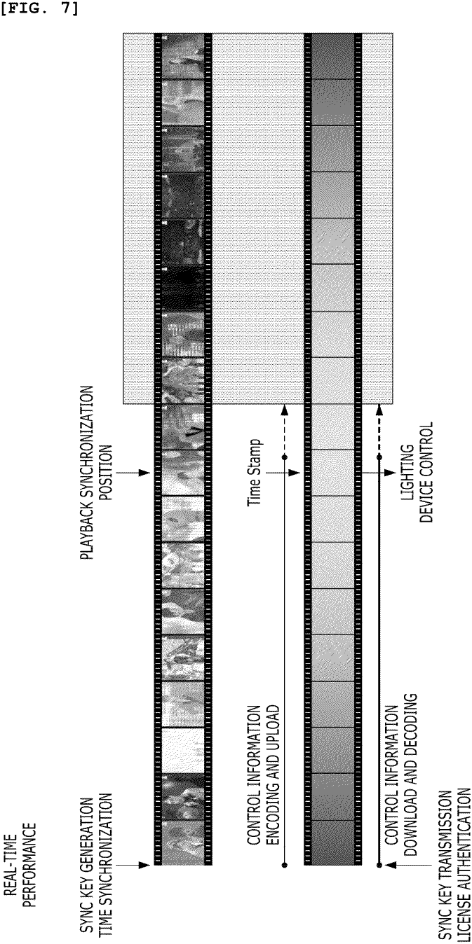

FIG. 9 represents a user device performing media content playback and wireless lighting device control according to an embodiment of the present disclosure.

A memory 9010 is connected to the processor 9020, and stores various data/information for driving the processor 9020. The memory 9010 may be included in the processor 9020, or installed outside the processor 9020 to be connected to the processor 9020 by a known means. The memory 9010 collectively refers to volatile and non-volatile memories. In the present disclosure, the memory 9010 may store a program, an application, or a program code for implementing the above-described lighting control method.

A processor 9020 may be connected to the memory 9010 to perform the control method of the present disclosure. At least one of a module, data, program, or software implementing the operation of the system 9000 according to various embodiments of the present disclosure described above may be stored in the memory 9010 and executed by the processor 9020. The processor 9030 may execute the method of the present disclosure by running an application/software for performing the method of the present disclosure. The processor 9030 may be provided with one or more processing chips.

The communication unit 9030 may perform wired communication or wireless communication with an external device of the system. The communication unit 9030 may include one or a plurality of communication chipsets. The communication unit 9030 may include a communication module, and may perform communication based on various communication protocols such as wired, Internet, 3G, 4G (LTE), 5G, WIFI, Bluetooth, NFC, zigbee, and the like. The communication unit 9030 may further include a plurality of sub-level communication elements operating according to each communication protocol.

By way of example, a user device 9000 may be included as a computing system in any electronic device. The user device 9000 or the processor 9020 of the user device may perform the media content playback and wireless lighting device control method of the present disclosure described above with reference to FIGS. 1 to 8.

Hereinafter, lighting control data and a transmission control method thereof according to an embodiment of the present disclosure will be described in more detail. The lighting control data may include information on a periodic signal indicating a lighting pattern. In the case of lighting control data, the lighting pattern may be defined using various periodic signals, thereby reducing the amount of transmitted data.

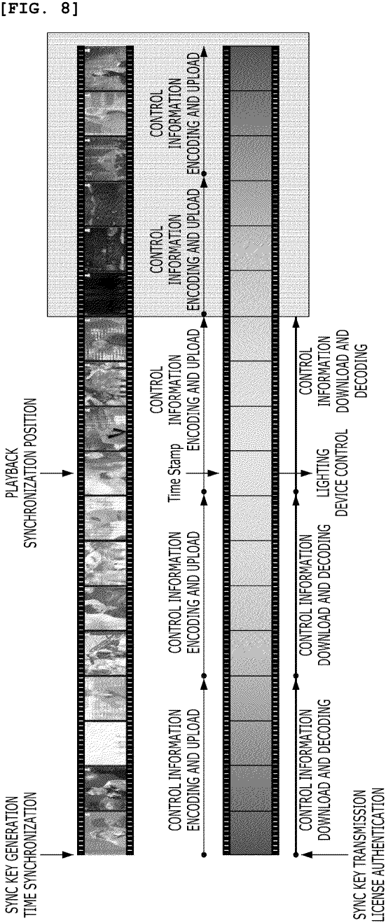

FIG. 10 represents a periodic signal indicating a lighting pattern according to an embodiment of the present disclosure.

In FIG. 10, the x-axis represents time, and the y-axis represents color. That is, the x-axis is a coordinate axis representing time, and the y-axis is a coordinate axis representing color displacement according to time. The y-axis color value may have RGBW color information. The period represents the amount of time taken until the waveform pattern repeats.

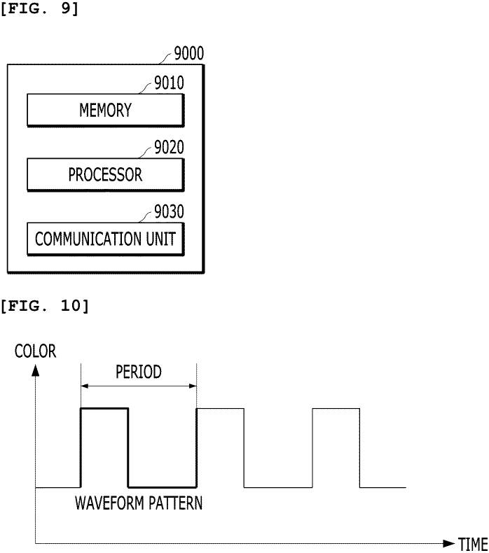

FIG. 11 represents various waveforms of a periodic function/signal according to an embodiment of the present disclosure. In FIG. 11, (a) represents a square wave; (b), a rectangular wave; (c), a sawtooth wave; (d), a triangular wave; (e), a step wave; (f), a pulse wave; (g), a sine wave; and (h), a complex wave. However, the waveform of FIG. 11 is provided as an example, and periodic functions used in the present disclosure are not limited to the examples of FIG. 11.

In an embodiment, the lighting control data may be delivered as a control format as shown in Table 2. Table 2 represents a control format according to an embodiment of the present disclosure.

TABLE 2

| BL-CODE | | TRANSMISSION TIME | | WAVEFORM PATTERN INDEX | WAVEFORM PATTERN COLOR VALUE | WAVEFORM PATTERN TIME VALUE |
|---|---|---|---|---|---|---|
| | | TRIGGER TIME | CORRECTION TIME | | | |
| COMPANY CODE | ARTIST CODE | Tsync | Ta | WP | Cn | Tn |

(1) BL-CODE: Product code. The product code may be used to identify a product group corresponding to a particular digital content. Alternatively, it may be used to identify an authenticated user device. (2) Transmission time: It indicates the transmission time point of the corresponding lighting control data. The transmission time information may include trigger time information and correction time information, and hereinafter may be represented as the trigger time information or the correction time information.

(2-1) Trigger Time (Tsync): The start time point of the waveform pattern. The user device may transmit the lighting control data in the control format shown in Table 2 at the trigger time. However, in the case of the lighting control data transmitted by the user device, the trigger time and the correction time may be excluded. The trigger time may be indicated as a relative time from the start time of the media data, or may be indicated as an absolute time synchronized with the media data. For example, if a specific lighting effect starts at 60 seconds after the start of the digital content, the trigger time of lighting control data providing the lighting effect may indicate 60 seconds. In another example, when the start time of the digital content is ‘15:00:00’, the trigger time of the lighting control data may be indicated as ‘15:01:00’.

(2-2) Correction time (Ta): Time for correcting time difference such as system delay, transmission/reception delay, or the like at trigger time. The user device may transmit the lighting control data at the time of applying the correction time to the trigger time. However, in the case of the lighting control data transmitted by the user device, the trigger time and the correction time may not be included. By using the correction time, it is possible to alleviate the problem of out of synchronization caused by data processing speed or hardware reasons such as data processing time between the media and the lighting device. Since the difference value of the response time of the lighting device is corrected based on the media playback position, the digital content and the lighting effect of the wireless lighting device can be more precisely synchronized.

(3) Waveform pattern index: An index, which defines a waveform pattern, may indicate at least one of index values assigned to preset functions/waveforms. The waveform pattern index may be referred to as lighting pattern information. The lighting pattern information may indicate at least one periodic function. The periodic function may be pre-stored in the lighting device, and only the index may be transmitted. Alternatively, a pattern of a periodic function may be transmitted. However, since the lighting effect without periodicity can also be indicated through the periodic function and waveform analysis information, the example of the present disclosure is not necessarily limited to the periodic function, so the waveform pattern index can represent/indicate any function representing the lighting effect.

(4) Wave pattern color value: It is a color factor value for the waveform pattern, and indicates at least one of lighting color and brightness. The waveform pattern color value indicates at least one of a lighting color or brightness of a lighting effect targeted by the corresponding lighting control data.

(5) Waveform pattern time value: It is a time factor value for the waveform pattern, and indicates additional information on the application of the waveform pattern. It may also be referred to as waveform pattern analysis information. The waveform pattern analysis information may indicate various modifications of a function indicated by the aforementioned waveform pattern index. The waveform pattern analysis information may indicate various function-related information, such as a slope, a period, a time length of a specific section, and the like of a function.

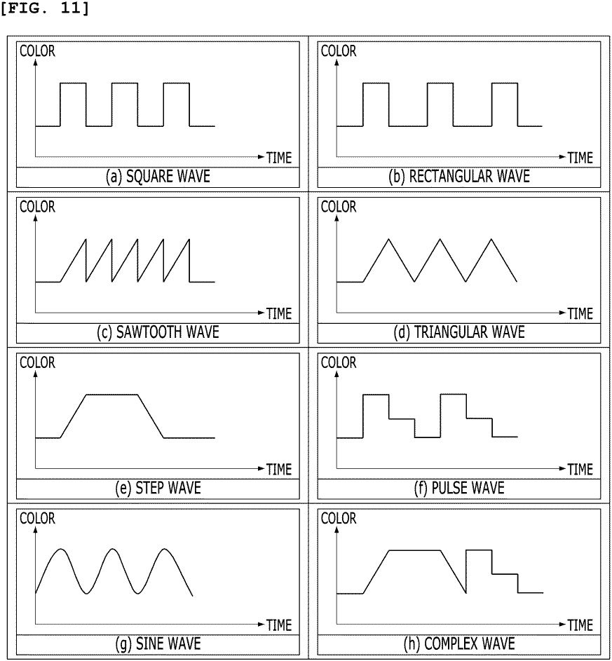

FIG. 12 represents a waveform pattern (A) of a periodic function/signal according to an embodiment of the present disclosure.

In FIG. 12, the trigger time indicates the application time of the corresponding periodic signal/function, and the user device transmits the lighting control data at the corresponding time point. The calibration time is used to more precisely synchronize the lighting of the wireless lighting device and the producing of the media content. The user device transmits the lighting control data at the time when the correction time is applied to the trigger time. That is, the wireless lighting device receives the lighting control data at the time when the correction time Ta is applied to the trigger time Tsync, and starts the corresponding lighting operation.

The operations indicated by the waveform patterns of FIG. 12 are as follows. The lighting device holds the color C1 (0, 0, 0, 0) value for Th1 (100 ms) at 10000 ms from the start of the synchronization target (digital content), and then sweeps the color over Ts1 (300 ms) time to the value of color C2 (255, 255, 0, 0). Then, the color C2 (255, 255, 0, 0) value is held for Th2 (200 ms) time, and then the color is swept to C1 (0, 0, 0, 0) value over Ts2 (400 ms) time. This is one cycle of waveform pattern A, and this operation is repeated unless there is a separate command. The separate command may mean lighting control data indicating a waveform pattern different from the waveform pattern of FIG. 12.

For the above-described operation control, the user device may transmit lighting control data such as the data format of Table 3.

TABLE 3

| BL-CODE | | TRIGGER TIME (ms) | CORRECTION TIME (ms) | WAVEFORM PATTERN INDEX | WAVEFORM PATTERN COLOR VALUE (RGBW) | WAVEFORM PATTERN TIME VALUE (ms) |
|---|---|---|---|---|---|---|
| A | 1 | 10000 | 0 | E | C1 (0, 0, 0, 0) C2 (255, 25 5,0,0) | TH1 (100) TS1 (300) TH2 (200) TS2 (400) |

(1) BL-CODE: The product code is A1. (2) Trigger time (Tsync): The trigger time is 10000 ms from the start time of the media data.

(3) Correction time (Ta): The correction time is 0 ms, and no correction is required.

(4) Waveform pattern index: The waveform pattern index is the step waveform A.

(5) Waveform pattern color value: The waveform pattern color value is C1(0,0,0,0) or C2(255,255,0,0). For example, C1 may indicate white and C2 may indicate red.

(6) Waveform pattern time value: The waveform pattern time value is Th1 (100 ms), Ts1 (300 ms), Th2 (200 ms), or Ts2 (400 ms).

As shown in FIG. 12, the user device that has received the control format as shown in Table 3 may provide the lighting in white for hold time 1, and may provide the lighting in red for hold time 2 after transition from white to red over sweep time 1, and the user device may repeat this operation until it receives the next lighting control data, after the transition from red to white over sweep time 2.

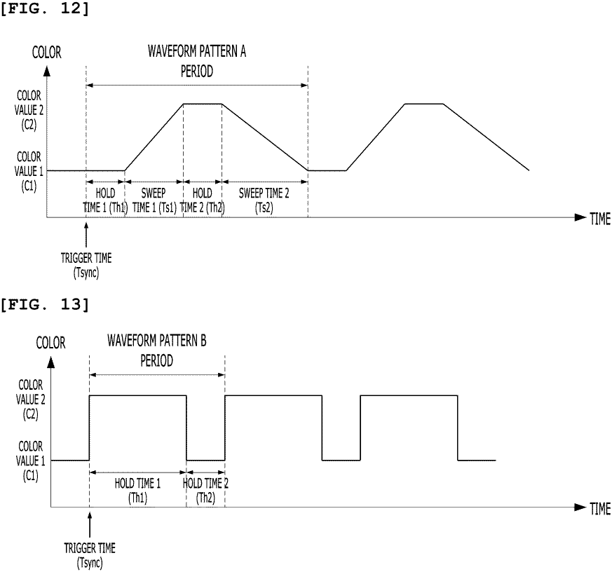

FIG. 13 represents a waveform pattern (B) of a periodic function/signal according to another embodiment of the present disclosure.

In FIG. 13, the trigger time indicates the application time of the corresponding periodic signal/function, and the user device transmits the lighting control data at the corresponding time point. The calibration time is used to more precisely synchronize the lighting of the wireless lighting device and the producing of the media content. The user device transmits the lighting control data at the time when the correction time is applied to the trigger time. That is, the wireless lighting device receives the lighting control data at the time when the correction time Ta is applied to the trigger time Tsync, and starts the corresponding lighting operation.

The operations indicated by the periodic signals of FIG. 13 and Table 4 are as follows. The lighting device holds the color C1 (255, 255, 255, 0) value for Th1 (800 ms) time at 20000 ms from the start of the synchronization target (digital content), and then holds the color C2 (0, 255, 0, 0) for Th2 (200 ms) time. This is one cycle of waveform pattern B, and this operation is repeated unless there is a separate command.

For the above-described operation control, the user device may transmit lighting control data such as the data format of Table 4.

TABLE 4

| BL-CODE | | TRIGGER TIME (ms) | CORRECTION TIME (ms) | WAVEFORM PATTERN INDEX | WAVEFORM PATTERN COLOR VALUE (RGBW) | WAVEFORM PATTERN TIME VALUE (ms) |
|---|---|---|---|---|---|---|
| A | 1 | 20000 | -5 | B | C1 (255, 255, 255, 0) C2 (0,255,0, 0) | Th1 (800) Th2 (200) |

(1) BL-CODE: The product code is A1. (2) Trigger time (Tsync): The trigger time is 10000 ms.

(3) Correction time (Ta) : The correction time is -5 ms.

(3) Waveform pattern index: The waveform pattern index is the step waveform E.

(4) Waveform pattern color values: The waveform pattern color value is C1(255,255,255,0) or C2 (0, 255, 0, 0) . For example, C1 may indicate white and C2 may indicate red.

(5) Waveform pattern time value: The waveform pattern time value is Th1 (800 ms), or Th2 (200 ms).

As shown in FIG. 13, the user device that has received the control format as shown in Table 4 may provide the lighting in blue for hold time 1 (Th1 = 800 ms), and provide the lighting in green during hold time 2 (Th2 = 200), and repeat this operation until it receives the next control format. The user device may transmit the data of Table 4 at a time point of 19995 ms reflecting -5 ms in 20000 ms, or transmit lighting control data excluding the trigger time and correction time from the data of Table 4.

The user device may receive the lighting control data as shown in Tables 2 to 4, and transmit the corresponding lighting control data at a time point indicated by the trigger time/correction time. When the lighting effect is a repeating pattern, transmission and data throughput can be greatly reduced by using a periodic function. For example, the wireless lighting device may be directed to provide the lightings repeatedly in white, blue, white, and then blue in this order at intervals of 1 second in the section of 60 seconds to 120 seconds of the performance image. In this case, if the periodic function is not used, lighting control data indicating the lighting color should be transmitted 60 times at an interval of 1 second. However, when using the periodic function of the present disclosure as shown in FIG. 13 and Table 4, the effect of an interval of 60 seconds to 120 seconds can be processed with single lighting control data transmission.

The user device may receive the lighting control data as shown in Tables 2 to 4, and transmit the corresponding lighting control data at a time point indicated by the lighting control data. However, in this case, since the transmission time information included in the lighting control data as shown in Tables 2 to 4 becomes unnecessary information for the wireless lighting device, the user device may transmit lighting control data excluding the transmission time information and some other information to the wireless lighting device. Hereinafter, in this case, the lighting control data that the user device receives from the lighting control server may be referred to as first lighting control data, and the lighting control data transmitted by the user device to the wireless lighting device may be referred to as second lighting control data. However, since it is not necessary to delete the above-described transmission time information and some other information, the first lighting control data and the second lighting control data may be the same data, and in this case, it can be regarded as a term that identifies only the sending/receiving subject. (In particular, because, in order to reduce delay for data processing, an embodiment in which the lighting control data received by the user device is transmitted as it is at the time of transmission may be considered.)

In addition, although the periodic function has been described as an example, it is not always possible to indicate only the periodic function. For example, by indicating the lighting color as black to an arbitrary periodic function, the lighting of the wireless lighting device can be terminated or stand-by. In addition, when lighting with the same color is continued in a specific period, this can be implemented by adjusting lighting analysis pattern information. For example, when the trigger time is 60 seconds and the red lighting is lit up for 1 minute, in the embodiment of FIG. 13, hold time 1 may be set to 1 minute and hold time 2 may be set to 0 to indicate this. And, if the next lighting control data is transmitted at the time of 120 seconds, a desired producing effect can be achieved.

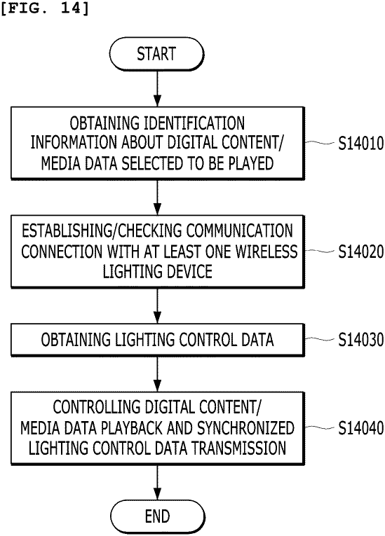

FIG. 14 represents a method of playing digital content by a user device and controlling a wireless lighting device according to an embodiment of the present disclosure. FIG. 14 represents a reconfiguration of the flowchart of FIG. 4 for explaining the invention.

The user device may obtain identification information on the media data of the digital content selected to be played (S14010). This identification information can be used to identify and obtain lighting control data to provide synchronized lighting effects. The lighting control data is set to have the same reference time as the media data. And the lighting control data shares identification information of the media data.

The user device may establish or check a communication connection with at least one wireless lighting device (S14020). If there is an already established communication connection, the user device only needs to check the connection. In an embodiment, the user device may identify a wireless lighting device capable of producing lighting for digital content or a connection thereof, and establish or check a communication connection with an appropriate wireless lighting device.

The user device may obtain lighting control data (S14030). By transmitting the identification information to the server, the user device may check the presence or absence of lighting control data corresponding to the corresponding digital content. As described above, the identification information may be the same as the identification information of the digital content. If the lighting control data exists, the user device may obtain the lighting control data for lighting control of the wireless lighting control device. The user device may receive the lighting control data in a streaming manner and transmit it to the wireless lighting device, or after receiving the lighting control data corresponding to the entire digital content, the user device may transmit it to the wireless lighting device at an appropriate time. As described above, the lighting control data received from the server may be referred to as first lighting control data.

The user device may control playback of the digital content/media data, and control transmission of the lighting control data synchronized with the playback of the media data (S14040). The user device may control real-time transmission of lighting control data to the wireless lighting device based on at least one event related to media data playback. As described above, the lighting control data transmitted by the user device to the wireless lighting device may be referred to as second lighting control data. According to an embodiment, the second lighting control data may be different from or the same as the first lighting control data.

As described above, the lighting control data may have the same reference time as the digital content/media data, and the same identification information as the media data may be shared/used. As shown in Tables 2 to 4, the transmission time point of the lighting control data may be indicated as a time from the reference time of the media data, or may be indicated as an absolute time having the reference time of the media data. Accordingly, a lighting effect synchronized with digital content can be provided.

The real-time transmission of the second lighting control data provides a lighting effect of the wireless lighting device. In addition, the lighting effect of the wireless lighting device by the real-time transmission of the second lighting control data is synchronized with the playback of the digital content.

When at least one event related to the media data playback is recognized, transmission start, transmission standby, or transmission termination of the second lighting control data may be performed in response to the event. As described in relation to Table 1, the second lighting control data of the present disclosure is transmitted in real time, and this transmission is controlled in conjunction with a playback-related event.

The media data and the first lighting data may be received from separate servers, respectively. However, this is only an embodiment, and they may be received from one server according to the data configuration of server or the content provider.

As described in FIGS. 10 to 13 and Tables 2 to 4, the second lighting control data may indicate at least one of a lighting pattern, a lighting color, and a lighting brightness of the wireless lighting device. Additionally, the first lighting control data includes transmission time point information indicating a transmission time point at which the second lighting data is transmitted, and the second lighting data is transmitted at the transmission time point. The second lighting control data may include lighting pattern information, lighting color information, and lighting pattern interpretation information, wherein the lighting pattern information may indicate at least one periodic function, the lighting color information may indicate at least one of a lighting color and brightness, and the lighting pattern interpretation information may indicate an additional value used to apply the periodic function. The transmission time information may further include trigger time information and correction time information for correcting the trigger time information, and the trigger time may indicate an application time point of the lighting effect to the media content, and the correction time information may indicate a correction time for the trigger time for additional synchronization of the lighting effect to the media content.

When the transmission standby of the second lighting control data is performed in response to the event, the second lighting control data corresponding to the transmission standby may be additionally transmitted. For example, in the case of the present disclosure, if the new second lighting control data is not transmitted, the wireless lighting device continues the lighting effect indicated by the previously transmitted second lighting control data. However, when the media content playback is stopped, the wireless lighting device may be controlled to stop lighting or generate a separate lighting effect corresponding to standby, instead of maintaining the existing lighting effect. To this end, by the occurrence of a specific event, the second lighting control data corresponding to the transmission standby may be additionally transmitted.

In case of an event in which the media content is played with the playback position changed, transmission of the second lighting control data may be resumed from the last second lighting control data preceding the time corresponding to the changed playback position. For example, the second lighting control data indicating the same lighting pattern for 60 seconds to 120 seconds from the start of the digital content may be transmitted. However, the user may request the playback of the digital content at the 90 second point by the content search. In this case, the user device may perform transmission from the last second lighting control data (indicating a lighting pattern of 60 seconds to 102 seconds) preceding the time (90 seconds) corresponding to the changed playback position.

The above-described method of the present disclosure may be implemented as an application or program, stored in a memory of a user device, and executed by the processor of the user device. The description of a user device practicing the present disclosure includes a method for such implementation.

Also, as described above, the user device performs the digital content playback and wireless lighting device control method. The user device may perform obtaining identification information about the media data of the digital content selected to be played; establishing a communication connection with at least one wireless lighting device; obtaining lighting control data for lighting control of the wireless lighting device for the media data by using the identification information; and controlling playback of the media data, and controlling transmission of the lighting control data to the wireless lighting device based on a relevant event of the media data playback. Media data may be received in advance, or may be received with buffering according to a playback command.

The lighting control data may be set to have the same reference time as the media data, and may share identification information of the media data.

The lighting control data indicates the lighting color and lighting timing of the wireless lighting device, and may be transmitted in a streaming manner.

The lighting control data may be transmitted, interrupted, or terminated based on the relevant event of media data playback.

The lighting control data may be transmitted as a periodic signal in which the x-axis is time and the y-axis is the color.

The embodiments described above are those in which elements and features of the present disclosure are combined in a predetermined form. Each component or feature should be considered optional unless explicitly stated otherwise. Each component or feature may be implemented in a form that is not combined with other components or features. It is also possible to configure embodiments of the present disclosure by combining some elements and/or features. The order of operations described in the embodiments of the present disclosure may be changed. Some components or features of one embodiment may be included in another embodiment, or may be replaced with corresponding components or features of another embodiment. It is apparent that claims that are not explicitly cited in the claims can be combined to form an embodiment, or included as a new claim by amendment after filing.

Embodiments according to the present disclosure may be implemented by various means, for example, hardware, firmware, software, or a combination thereof. In the case of implementation by hardware, an embodiment of the present disclosure may be implemented by one or more application specific integrated circuits (ASICs), digital signal processors (DSPs), digital signal processing devices (DSPDs), programmable logic devices (PLDs), FPGAs (field programmable gate arrays), processors, controllers, microcontrollers, microprocessors, and the like.

In the case of implementation by firmware or software, an embodiment of the present disclosure may be implemented in the form of a module, procedure, function, or the like that perform the functions or operations described above. The software code may be stored in the memory and run by the processor. The memory may be located inside or outside the processor, and may transmit and receive data to and from the processor by various known means.

It is apparent to those skilled in the art that the present disclosure may be embodied in other specific forms without departing from the essential characteristics of the present disclosure. Therefore, the detailed description above should not be interpreted in a limited way but should be considered as an example. The scope of the invention shall be determined by a reasonable interpretation of the claims attached, and all changes within the equivalent range of the invention are within the scope of the invention.

### Description of Embodiments

Various embodiments have been described in the best mode for carrying out the present disclosure.

### Industrial Applicability

The present disclosure is used in a series of lighting effect producing and entertainment fields.

It will be apparent to those skilled in the art that various changes and modifications can be made in the present disclosure without departing from the technical idea or scope of the present disclosure. Accordingly, this invention is intended to cover the modifications and variations of this invention provided within the scope of the appended claims and their equivalents.

1. A method for controlling digital content playback and a wireless lighting device synchronized with the digital content playback, the method comprising:
obtaining identification information about media data of the digital content selected to be played;
establishing a communication connection with at least one wireless lighting device;
obtaining first lighting control data for lighting control of the wireless lighting device for the digital content by using the identification information; and
controlling playback of the media data, and controlling real-time transmission of second lighting control data to the wireless lighting device based on at least one event related to the playback of the media data.

2. The method of claim 1, wherein the first lighting control data has a same reference time as the media data, and shares the identification information with the media data.

3. The method of claim 1, wherein the real-time transmission of the second lighting control data provides a lighting effect of the wireless lighting device, and
wherein the lighting effect of the wireless lighting device by the real-time transmission of the second lighting control data is synchronized with the playback of the digital content.

4. The method of claim 1, wherein when the at least one event related to the media data playback is recognized, transmission start, transmission standby, or transmission termination of the second lighting control data is performed in response to the event.

5. The method of claim 1, wherein the media data and the first lighting control data are received from separate servers, respectively.

6. The method of claim 1, wherein the second lighting control data indicates at least one of a lighting pattern, a lighting color, and a lighting brightness of the wireless lighting device.

7. The method of claim 6, wherein the first lighting control data includes transmission time point information indicating a transmission time point at which the second lighting data is transmitted, and the second lighting data is transmitted at the transmission time point.

8. The method of claim 6, wherein the second lighting control data includes lighting pattern information, lighting color information, and lighting pattern interpretation information, and
wherein the lighting pattern information indicates at least one periodic function, the lighting color information indicates at least one of a lighting color and a lighting brightness, and the lighting pattern interpretation information indicates an additional value used to apply the periodic function.

9. The method of claim 7, wherein the transmission time information further includes trigger time information and correction time information for correcting the trigger time information, and
wherein the trigger time indicates an application time point of the lighting effect to the media content, and the correction time information indicates a correction time for the trigger time for additional synchronization of the lighting effect with the media content.

10. The method of claim 3, wherein when a transmission standby of the second lighting control data is performed in response to the event, the second lighting control data corresponding to the transmission standby is additionally transmitted.

11. A user device for controlling digital content playback and a wireless lighting device, the user device comprising:
a memory storing data;
a communication unit which performs communication with an external device; and
a processor connected to the memory and the communication unit, and operating the user device,
the user device is configured to:
obtain identification information about media data of the digital content selected to be played;
establish a communication connection with at least one wireless lighting device;
obtain first lighting control data for lighting control of the wireless lighting device for the digital content by using the identification information; and
control playback of the media data, and control real-time transmission of second lighting control data to the wireless lighting device based on at least one event related to the playback of the media data.

12. The user device of claim 11, wherein the first lighting control data has a same reference time as the media data, and shares the identification information with the media data.

13. The user device of claim 11, wherein the real-time transmission of the second lighting control data provides a lighting effect of the wireless lighting device, and
wherein the lighting effect of the wireless lighting device by the real-time transmission of the second lighting control data is synchronized with the playback of the digital content.

14. The user device of claim 11, wherein when the at least one event related to the media data playback is recognized, transmission start, transmission standby, or transmission termination of the second lighting control data is performed in response to the event.

15. The user device of claim 11, wherein the media data and the first lighting control data are received from separate servers, respectively.

16. The user device of claim 11, wherein the second lighting control data indicates at least one of a lighting pattern, a lighting color, and a lighting brightness of the wireless lighting device.

17. The user device of claim 16, wherein the first lighting control data includes transmission time point information indicating a transmission time point at which the second lighting data is transmitted, and the second lighting data is transmitted at the transmission time point.

18. The user device of claim 16, wherein the second lighting control data includes lighting pattern information, lighting color information, and lighting pattern interpretation information, and
wherein the lighting pattern information indicates at least one periodic function, the lighting color information indicates at least one of a lighting color and a lighting brightness, and the lighting pattern interpretation information indicates an additional value used to apply the periodic function.

19. The user device of claim 17, wherein the transmission time information further includes trigger time information and correction time information for correcting the trigger time information, and
wherein the trigger time indicates an application time point of the lighting effect to the media content, and the correction time information indicates a correction time for the trigger time for additional synchronization of the lighting effect with the media content.

20. The user device of claim 13, wherein when a transmission standby of the second lighting control data is performed in response to the event, the second lighting control data corresponding to the transmission standby is additionally transmitted.
